(19) United States
(12) Patent Application Publication
(10) Pub. No.: US 2025/0357568 A1
(43) Pub. Date: Nov. 20, 2025

(54) APPARATUS AND METHOD FOR RECYCLING ELECTRONIC COMPONENTS BEARING LITHIUM BATTERY

(71) Applicant: Wistron GreenTech (Texas) Corporation, McKinney, TX (US)

(72) Inventors: Jerry Nien Tsu WANG, Southlake, TX (US); Li-Hsien CHOU, McKinney, TX (US); Chih Long HUANG, McKinney, TX (US)

(73) Assignee: Wistron GreenTech (Texas) Corporation, McKinney, TX (US)

(21) Appl. No.: 19/206,447

(22) Filed: May 13, 2025

Related U.S. Application Data
(60) Provisional application No. 63/647,212, filed on May 14, 2024.

(51) Int. Cl. H01M 10/54; B04B 3/00; B09B 3/32; B09B 3/35; B09B 3/40; B09B 101/16

(52) U.S. Cl. CPC H01M 10/54; B04B 3/00; B09B 3/32; B09B 3/35; B09B 3/40; B09B 2101/16

(57) ABSTRACT

An apparatus comprises a single axle shredder device, a double axle shredder device, a variable frequency furnace, a first rotary device, a second rotary device, a crushing device, a first filtering, a second filtering, a transporting device, a sorting equipment, an extruding device, a separation equipment and a black mass collector. A method for recycling electronic components bearing lithium battery, includes: inputting first gas to a single axle shredder device and a double axle shredder device selectively, and to a variable frequency furnace, inputting electronic components with lithium battery to the single axle shredder device and the double axle shredder device selectively, tearing the electronic components with lithium battery into a plurality of pieces by the single axle shredder device and the double axle shredder device selectively, supplying the pieces to the variable frequency furnace via a channel and heating the pieces within the variable frequency furnace.

### CROSS-REFERENCE TO RELATED APPLICATIONS

This application claims the benefit of U.S. provisional application Ser. No. 63/647,212 filed May 14, 2024, the disclosure of which is hereby incorporated in its entirety by reference herein.

### TECHNICAL FIELD

The disclosure relates to an apparatus and a method, and particularly relates to an apparatus and a method for recycling electronic components bearing lithium battery.

### BACKGROUND

### Related Art

Lithium batteries are used in many products such as electronics, wireless headphones, small and large appliances, electric vehicles and electrical energy storage systems. If not properly managed at the end of their useful life, Lithium batteries may harm the environment. Recycling used lithium batteries will clean energy transition and prevent inappropriate battery disposal.

### SUMMARY

The disclosure provides an apparatus and a method for recycling electronic components bearing lithium battery.

In one embodiment of the disclosure, the apparatus comprises a single axle shredder device, a double axle shredder device, a variable frequency furnace, a first rotary device, a second rotary device, a crushing device, a first filtering, a second filtering, a transporting device, a sorting equipment, an extruding device, a separation equipment and a black mass collector. In one embodiment of the disclosure, the method for recycling electronic components bearing lithium battery, the method includes: inputting first gas to a single axle shredder device and a double axle shredder device selectively and to a variable frequency furnace, inputting electronic components with lithium battery to the single axle shredder device and the double axle shredder device selectively, tearing the electronic components with lithium battery into a plurality of pieces by the single axle shredder device and the double axle shredder device selectively, and supplying the plurality of pieces to the variable frequency furnace via a channel and heating the plurality of pieces within the variable frequency furnace.

### BRIEF DESCRIPTION OF THE DRAWINGS

FIG. 1 is a schematic diagram illustrating an apparatus for recycling electronic components bearing lithium battery according to an embodiment of the disclosure.

FIG. 2 is a schematic diagram illustrating an electrolyte recycle system according to an embodiment of the disclosure.

FIG. 3 is a schematic diagram showing actual object of the double axle shredder device according to an embodiment of the disclosure.

FIG. 4 is a schematic diagram showing actual object of the single axle shredder device according to an embodiment of the disclosure.

FIG. 5 is a schematic diagram showing actual object of the variable frequency furnace according to an embodiment of the disclosure.

FIG. 6-1 is a schematic diagram showing actual object of the first rotary device according to an embodiment of the disclosure.

FIG. 6-2 is a schematic diagram showing actual object of the first rotary device according to an embodiment of the disclosure.

FIG. 6-3 is a schematic diagram showing actual object of the first rotary device according to an embodiment of the disclosure.

FIG. 7 is a schematic diagram showing actual object of the first filtering according to an embodiment of the disclosure.

FIG. 8 is a schematic diagram showing actual object of the transporting device according to an embodiment of the disclosure.

FIG. 9 is a schematic diagram showing actual object of the sorting equipment according to an embodiment of the disclosure.

FIG. 10 is a schematic diagram showing actual object of the crushing device according to an embodiment of the disclosure.

FIG. 11 a schematic diagram showing actual object of the second filtering according to an embodiment of the disclosure.

FIG. 12 a schematic diagram showing actual object of the dust removal device according to an embodiment of the disclosure.

FIG. 13 is a schematic diagram illustrating inner filter and outer filter of the rotary device according to an embodiment of the disclosure.

FIG. 14 is a flowchart illustrating steps of the method for recycling electronic components bearing lithium battery according to an embodiment of the disclosure.

FIG. 15 is a flowchart illustrating steps of the method for recycling electronic components bearing lithium battery according to an embodiment of the disclosure.

FIG. 16 is a flowchart illustrating steps of the method for recycling electronic components bearing lithium battery according to an embodiment of the disclosure.

FIG. 17 is a flowchart illustrating steps of the method for recycling electronic components bearing lithium battery according to an embodiment of the disclosure.

FIG. 18 is a flowchart illustrating steps of the method for recycling electronic components bearing lithium battery according to an embodiment of the disclosure.

FIG. 19 is a flowchart illustrating steps of the method for recycling electronic components bearing lithium battery according to an embodiment of the disclosure.

FIG. 20 is a flowchart illustrating steps of the method for recycling electronic components bearing lithium battery according to an embodiment of the disclosure.

FIG. 21 is a flowchart illustrating steps of the method for recycling electronic components bearing lithium battery according to an embodiment of the disclosure.

FIG. 22 is a flowchart illustrating steps of the method for recycling electronic components bearing lithium battery according to an embodiment of the disclosure.

FIG. 23 is a flowchart illustrating a step of the method for recycling electronic components bearing lithium battery according to an embodiment of the disclosure.

FIG. 24 is a flowchart illustrating steps of the method for recycling electronic components bearing lithium battery according to an embodiment of the disclosure.

FIG. 25 is a flowchart illustrating a step of the method for recycling electronic components bearing lithium battery according to an embodiment of the disclosure.

FIG. 26 is a flowchart illustrating steps of the method for recycling electronic components bearing lithium battery according to an embodiment of the disclosure.

FIG. 27 is a flowchart illustrating steps of the method for recycling electronic components bearing lithium battery according to an embodiment of the disclosure.

FIG. 28 is a flowchart illustrating steps of the method for recycling electronic components bearing lithium battery according to an embodiment of the disclosure.

FIG. 29 is a flowchart illustrating steps of the method for recycling electronic components bearing lithium battery according to an embodiment of the disclosure.

FIG. 30 is a flowchart illustrating steps of the method for recycling electronic components bearing lithium battery according to an embodiment of the disclosure.

FIG. 31 is a flowchart illustrating steps of the method for recycling electronic components bearing lithium battery according to an embodiment of the disclosure.

FIG. 32 is a flowchart illustrating steps of the method for recycling electronic components bearing lithium battery according to an embodiment of the disclosure.

FIG. 33 is a flowchart illustrating steps of the method for recycling electronic components bearing lithium battery according to an embodiment of the disclosure.

FIG. 34 is a flowchart illustrating steps of the method for recycling electronic components bearing lithium battery according to an embodiment of the disclosure.

FIG. 35 is a flowchart illustrating steps of the method for recycling electronic components bearing lithium battery according to an embodiment of the disclosure.

FIG. 36 is a diagram showing an operational test result of the apparatus and the method for recycling electronic components bearing lithium battery according to an embodiment of the disclosure.

### DETAILED DESCRIPTION

Some embodiments of the disclosure will now be described in detail with reference to the accompanying drawings. These embodiments are merely a part of the disclosure and do not disclose all possible implementations of the disclosure. More precisely, these embodiments are merely examples within the scope of the appended claims of the disclosure.

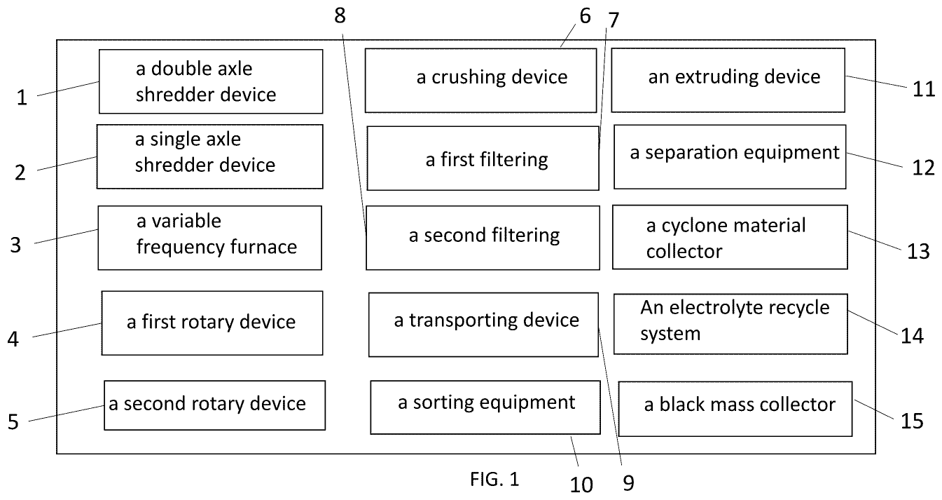

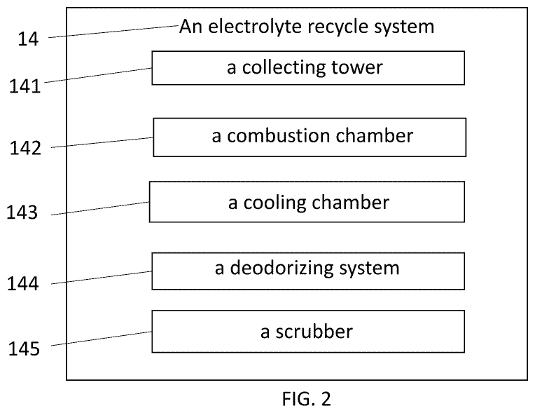

Please refer to FIG. 1, a schematic diagram illustrating an apparatus for recycling electronic components bearing lithium battery according to an embodiment of the disclosure is shown. In one embodiment, apparatus for recycling electronic components bearing lithium battery comprises a double axle shredder device 1, a single axle shredder device 2, a variable frequency furnace 3, a first rotary device 4, a second rotary device 5, a crushing device 6, a first filtering 7, a second filtering 8, a transporting device 9, a sorting equipment 10, an extruding device 11, a separation equipment 12, a cyclone material collector (a.k.a. dust removal device) 13, an electrolyte recycle system 14 and a black mass collector 15. Please refer to FIG. 2, a schematic diagram illustrating an electrolyte recycle system according to an embodiment of the disclosure is shown. The electrolyte recycle system 14 includes a collecting tower 141, a combustion chamber 142, a cooling chamber 143, a deodorizing system 144 and a scrubber 145. Aforementioned scrubber 145 generates a water vapor and a water curtain. Aforementioned scrubber 145 has a pool.

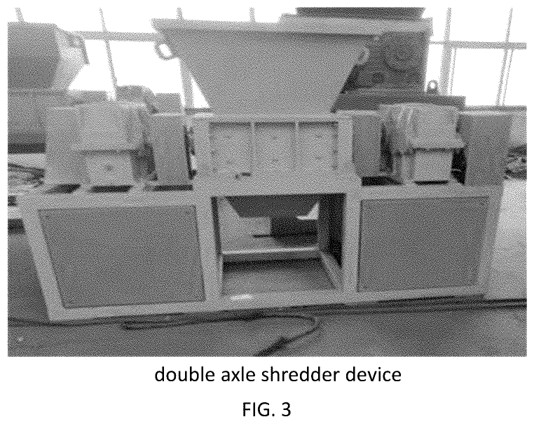

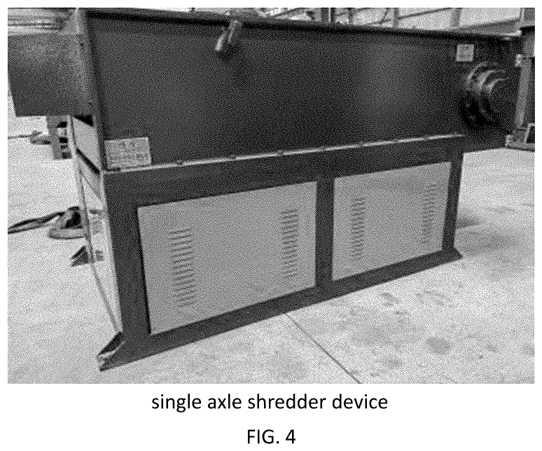

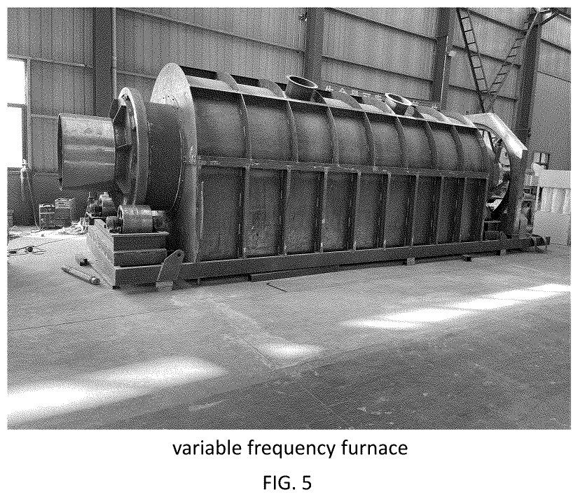

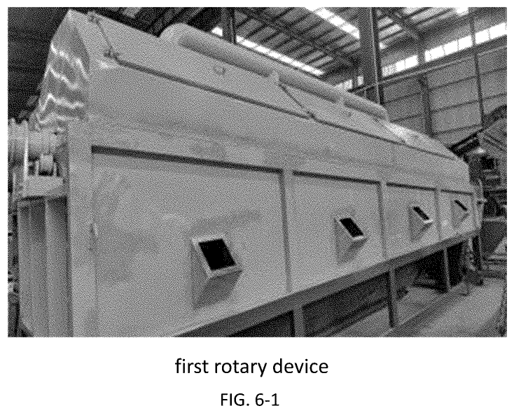

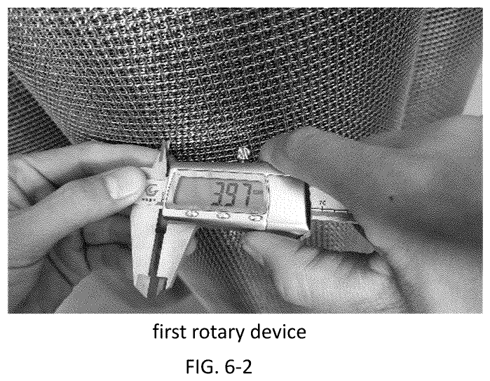

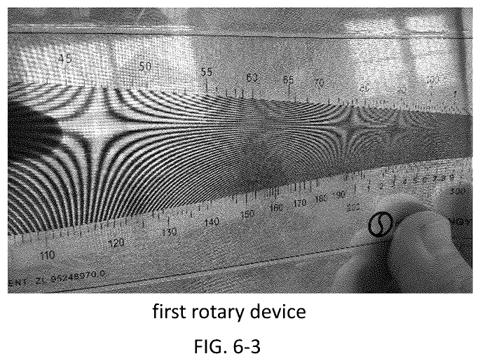

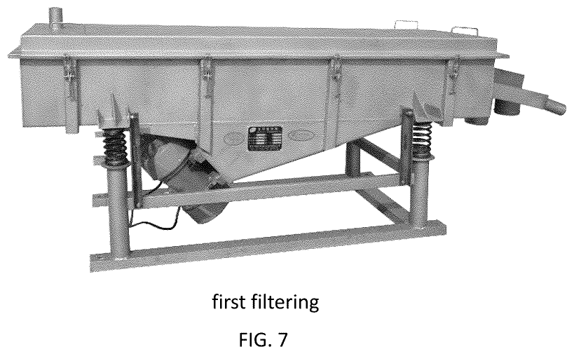

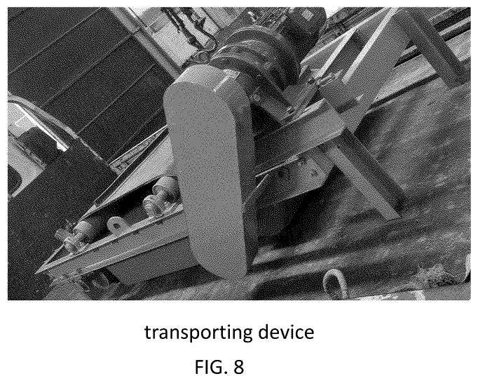

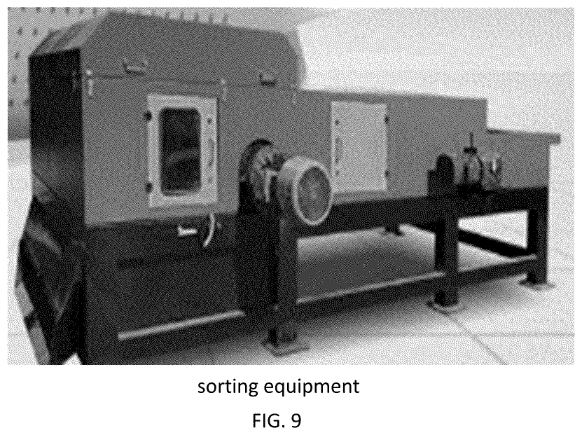

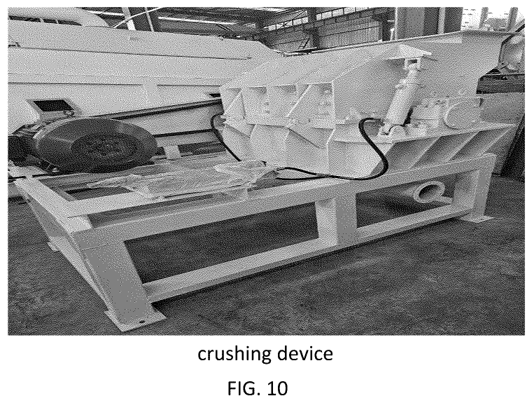

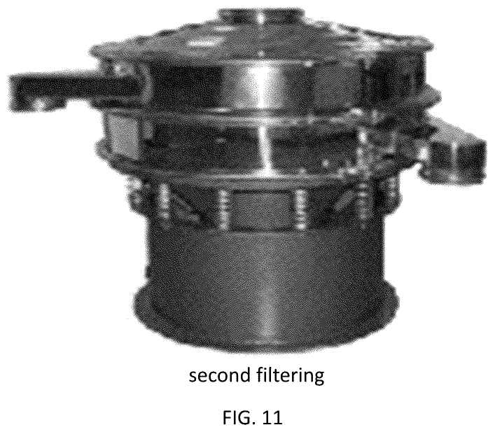

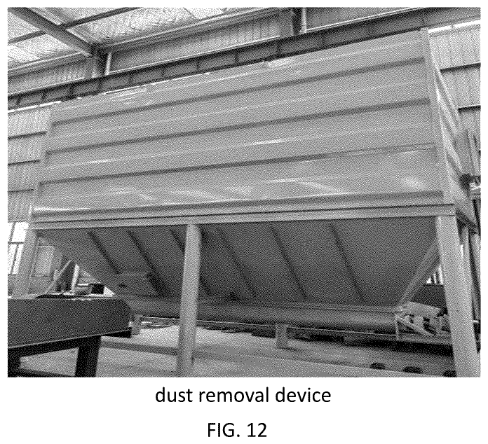

Still, for actual object of the double axle shredder device 1, please refer to FIG. 3, which is a schematic diagram showing actual object of the double axle shredder device according to an embodiment of the disclosure. For actual object of the single axle shredder device 2, please refer to FIG. 4, which is a schematic diagram showing actual object of the single axle shredder device according to an embodiment of the disclosure. For actual object for the variable frequency furnace 3, please refer to FIG. 5, which is a schematic diagram showing actual object of the variable frequency furnace according to an embodiment of the disclosure. For actual object of the first rotary device 4, please refer to FIGS. 6-1˜6-2, and 6-3, which are schematic diagrams showing actual object of the first rotary device according to an embodiment of the disclosure. For actual object for the first filtering 7, please refer to FIG. 7, which is a schematic diagram showing actual object of the first filtering according to an embodiment of the disclosure. For actual object of the transporting device 9, please refer to FIG. 8, which is a schematic diagram showing actual object of the transporting device according to an embodiment of the disclosure. For actual object of the sorting equipment 10, please refer to FIG. 9, which is a schematic diagram showing actual object of the sorting equipment according to an embodiment of the disclosure. For actual object of the crushing device 6, please refer to FIG. 10, which is a schematic diagram showing actual object of the crushing device according to an embodiment of the disclosure. For actual object of the second filtering 8, please refer to FIG. 11, which is a schematic diagram showing actual object of the second filtering according to an embodiment of the disclosure. For actual object of the dust removal device 13, please refer to FIG. 12, which is a schematic diagram showing actual object of the dust removal device 13 according to an embodiment of the disclosure.

Aforementioned double axle shredder device 1 has a plurality of blades (Not shown in FIG. 3). Each of the blades is made by carbon steel (C: 0.6%˜2%) or Alloy steel (C: 0.13-0.18; CR: 0.90-1.20). Said crushing device 6 is, for example, a Hammer mill. Said transporting device 9 is, for example, Iron Removal. Said sorting equipment 10 is, for example, eddy current. Said second filtering 8 is, for example, a Circular Sieve. Said extruding device 11 is, for example, a ball generator. Said separation equipment 12 is, for example, a Density Separator. Said dust removal device 13 is, for example, a pulse dust collector.

Said double axle shredder device 1, said single axle shredder device 2, said variable frequency furnace 3, said first rotary device 4, said second rotary device 5, said crushing device 6, said first filtering 7, said second filtering 8, said transporting device 9, said sorting equipment 10, said extruding device 11, said separation equipment 12, said dust removal device 13, said electrolyte recycle system 14 and said black mass collector 15 are connected to each other through one or more channels.

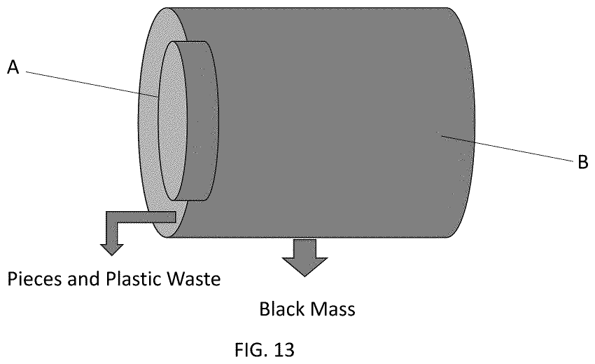

Please further refer to FIG. 13, which is a schematic diagram illustrating inner filter and outer filter of the rotary device according to an embodiment of the disclosure The first rotary device 4 or the second rotary device 5 comprises an inner filter A and an outer filter B. An aperture size to the inner filter A of the first rotary device 4 is, for example, 14 mm. An aperture size to the outer filter B of the first rotary device 4 is, for example, 106 um. Whereas, an aperture size to the inner filter A of the second rotary device 5 is, for example, 4 mm. An aperture size to the outer filter B of the second rotary device 5 is, for example, 106 um. Aforementioned aperture size 4 mm or 14 mm to the inner filter A, and aforementioned aperture size 106 um of the outer filter B are examples, not limited thereto.

After electronic components with lithium battery tear being torn into pieces, and a separator and an electrostatic discharge materials (ESD) material of the lithium battery being transformed into plastic waste, pieces and plastic waste enter into the first rotary device 4 or the second rotary device 5. The pieces and plastic waste smaller than the aperture size of the inner filter A will be filtered out and collected between inner filter A and outer filter B. Black mass smaller than the aperture size of the outer filter B will be filtered out.

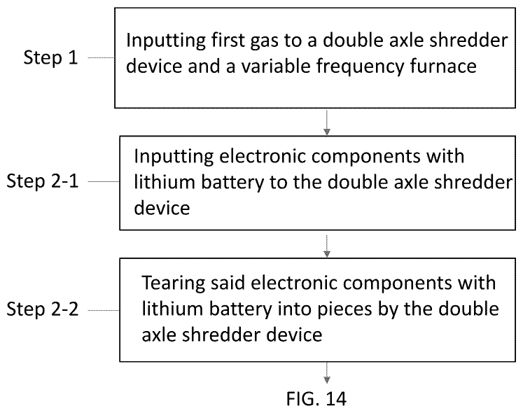

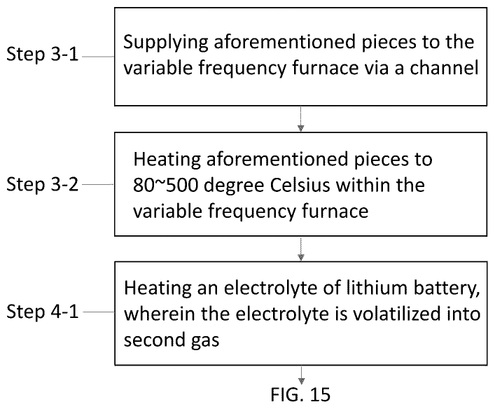

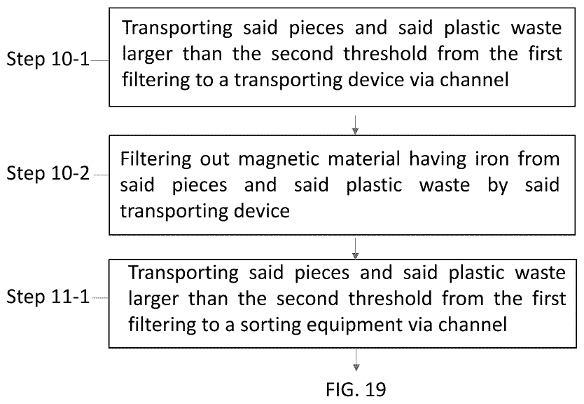

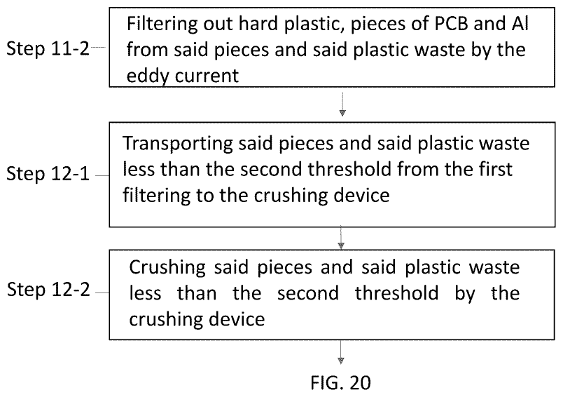

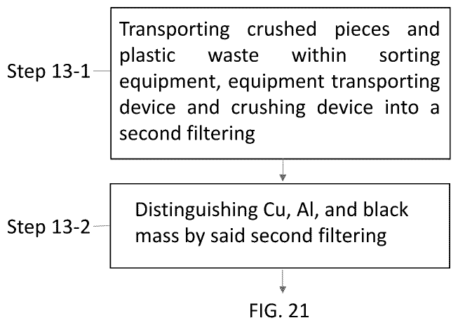

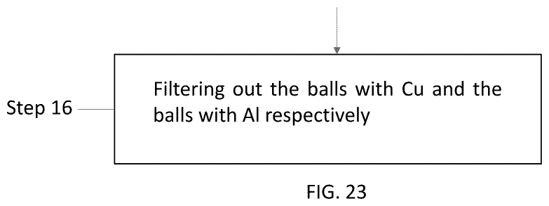

Please refer to FIG. 14 through FIGS. 23, which are the flowcharts illustrating steps of the method for recycling electronic components bearing lithium battery according to an embodiment of the disclosure. The steps of the method about how main apparatus operates are described as follows:
Step 1: Inputting first gas to a double axle shredder device and a variable frequency furnace, aforementioned double axle shredder device has a plurality of blades, each of the blades is made by carbon steel (C: 0.6%˜2%), or Alloy steel (C: 0.13-0.18; CR: 0.90-1.20), wherein aforementioned first gas is, for example, Nitrogen;
Step 2-1: Inputting electronic components with lithium battery to the double axle shredder device;
Step 2-2: Tearing said electronic components with lithium battery into pieces by the double axle shredder device, wherein the size of each of aforementioned pieces is from 1 mm to 30 mm;
Step 3-1: Supplying aforementioned pieces to the variable frequency furnace via a channel;
Step 3-2 Heating aforementioned pieces to 80˜500 degree Celsius within the variable frequency furnace, wherein a separator and an ESD material of the lithium battery are transformed into plastic waste through heat shrink, the size of each of aforementioned plastic waste is from 1 mm to 18 mm;
Step 4-1: Heating an electrolyte of lithium battery, wherein the electrolyte is volatilized into second gas;
Step 4-2: Exhausting second gas into the electrolyte recycle system via channel, wherein aforementioned second gas is cooled and cleaned in the electrolyte recycle system, wherein aforementioned heated, then cooled pieces and plastic waste enter into a first rotary device via channel;
Step 5: Filtering out plastic waste smaller than 1 mm to 18 mm and 10% black mass within electronic components with lithium battery by the first rotary device;
Step 6-1: Putting pieces within 14 mm to 20 mm and plastic waste within 14 mm to 20 mm into a single axle shredder device;
Step 6-2: Tearing said pieces within 12 mm to 22 mm and plastic waste within 12 mm to 22 mm into pieces within 2 mm to 5 mm and plastic waste within 2 mm to 5 mm, wherein aforementioned said pieces within 2 mm to 5 mm pieces enter into a second rotary device via channel;
Step 7: Filtering out said pieces smaller than a first threshold, for example, 1 mm to 5 mm, and 70% black mass within electronic components with lithium battery by the second rotary device;
Step 8-1: Putting pieces larger than the first threshold, for example, 1 mm to 5 mm and plastic waste larger than the first threshold, for example, 1 mm to 5 mm into a crushing device, wherein said crushing device is, for example, a Hammer mill;
Step 8-2: Crushing said pieces and said plastic waste larger than the first threshold, for example, 1 mm to 5 mm, by the crushing device;
Step 9-1: Distinguishing by a first filtering, whether said pieces and said plastic waste being larger or less than a second threshold, wherein the second threshold is, for example, 3.5 mm, wherein said first filtering is, for example, a vibration sieve;
Step 9-2: Filtering out 10% black mass within electronic components with lithium battery by the first filtering;
Step 10-1: Transporting said pieces and said plastic waste larger than the second threshold from the first filtering to a transporting device via channel, said transporting device is, for example, Iron Removal;
Step 10-2: Filtering out magnetic and iron materials from said pieces and said plastic waste by said transporting device;
Step 11-1: Transporting said pieces and said plastic waste larger than the second threshold from the transporting device to a sorting equipment via channel, wherein said sorting equipment is, for example, eddy current;
Step 11-2: Filtering out hard plastic, pieces of printed circuit board (PCB) and Al from said pieces and said plastic waste by the eddy current;
Step 12-1: Transporting said pieces and said plastic waste less than the second threshold from the first filtering to the crushing device, wherein said crushing device is, for example, a Hammer mill;
Step 12-2: Crushing said pieces and said plastic waste less than the second threshold by the crushing device;
Step 13-1: Transporting crushed pieces and plastic waste within sorting equipment, transporting device and crushing device into a second filtering, wherein said second filtering is, for example, a Circular Sieve;
Step 13-2: Distinguishing Cu, Al, and black mass by said second filtering;
Step 13-3: Filtering out 5% black mass within electronic components with lithium battery by said second filtering;
Step 14: Extruding Cu, Al to a plurality of balls with Cu and a plurality of balls with Al by an extruding device respectively, wherein said extruding device is, for example, a ball generator;
Step 15: Putting the balls with Cu and the balls with Al into a separation equipment, wherein the separation equipment is, for example, a Density Separator;
Step 16: Filtering out the balls with Cu and the balls with Al respectively, wherein the size of each of aforementioned balls with Cu and the balls with Al is from 0.5 mm to 2 mm.

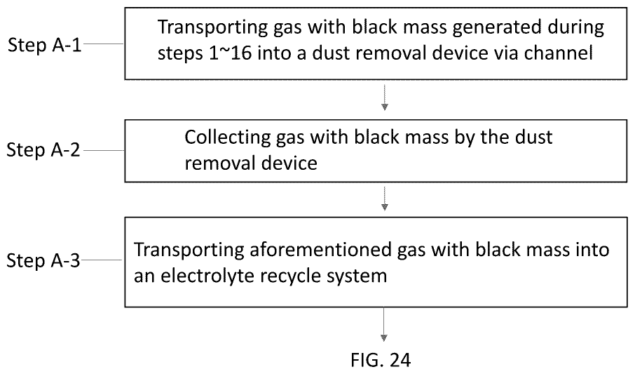

Please refer to FIG. 24, which is a flowchart illustrating steps of the method for recycling electronic components bearing lithium battery according to an embodiment of the disclosure. The steps of the method about how sub apparatus operates are described as follows:
Step A-1: Transporting gas with black mass generated during steps 1˜16 into a dust removal device via channel, wherein aforementioned dust removal device is, for example, a pulse dust collector;
Step A-2: Collecting gas with black mass by the dust removal device;
Step A-3: Transporting aforementioned gas with black mass into an electrolyte recycle system, wherein 5% black mass within electronic components with lithium battery is collected by the dust removal device.

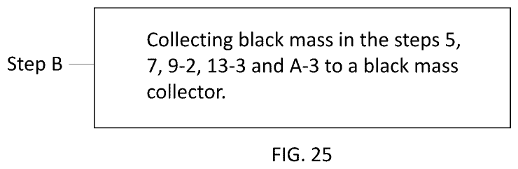

Please refer to FIG. 25, which is a flowchart illustrating a step of the method for recycling electronic components bearing lithium battery according to an embodiment of the disclosure. The step of the method about how sub apparatus operates is described as follows:
Step B: Collecting black mass in the steps 5, 7, 9-2, 13-3 and A-3 to a black mass collector.

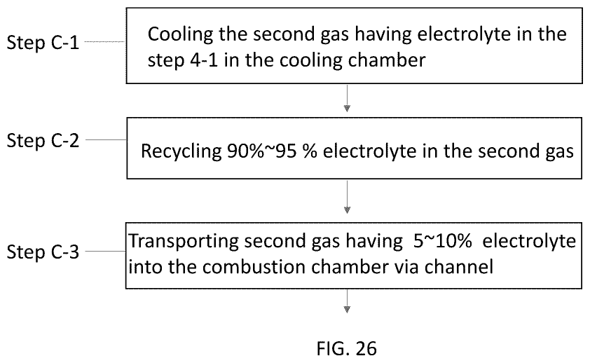

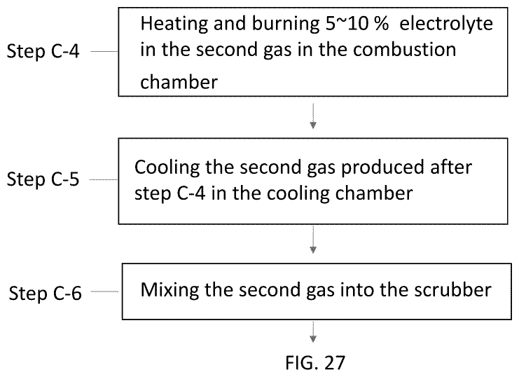

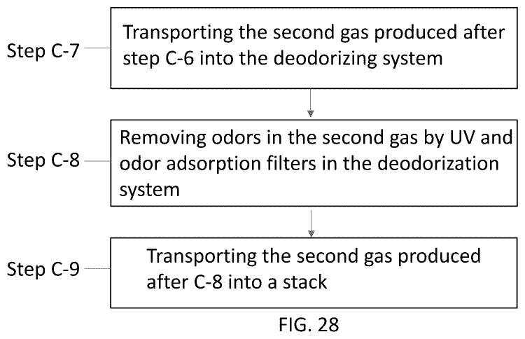

Please refer to FIGS. 26, 27 and 28, which are flowcharts illustrating steps of the method for recycling electronic components bearing lithium battery according to an embodiment of the disclosure. The steps of the method about how sub apparatus operates are described as follows:
Step C-1: Cooling the second gas having electrolyte in the step 4-1 in the cooling chamber;
Step C-2: Recycling 90%˜95% electrolyte in the second gas;
Step C-3: Transporting second gas having 5%˜10% electrolyte into the combustion chamber via channel;
Step C-4: Heating and burning 5%˜10% electrolyte in the second gas in the combustion chamber;
Step C-5: Cooling the second gas produced after step C-4 in the cooling chamber;
Step C-6: Mixing the second gas into the scrubber;
Step C-7: Transporting the second gas produced after step C-6 into the deodorizing system;
Step C-8: Removing odors in the second gas by ultraviolet (UV) and odor adsorption filters in the deodorization system;
Step C-9: Transporting the second gas produced after C-8 into a stack above the apparatus for recycling electronic components bearing lithium battery.

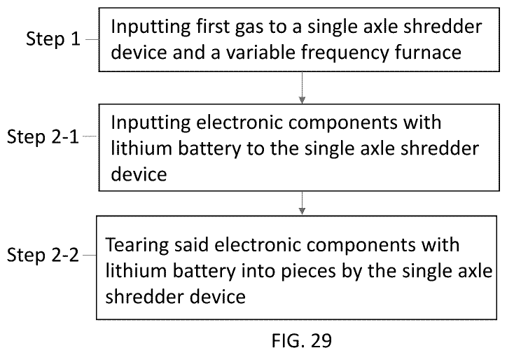

Please refer to FIG. 29, which is a flowchart illustrating steps of the method for recycling electronic components bearing lithium battery according to an embodiment of the disclosure. The steps of the method differing from the ones in FIG. 14 are described as follows:
Step 1: Inputting first gas to a single axle shredder device and a variable frequency furnace, aforementioned double axle shredder device has a plurality of blades, each of the blades is made by carbon steel (C: 0.6%˜2%), or Alloy steel (C: 0.13-0.18; CR: 0.90-1.20), wherein aforementioned first gas is, for example, Nitrogen;
Step 2-1: Inputting electronic components with lithium battery to the single axle shredder device;
Step 2-2: Tearing said electronic components with lithium battery into pieces by the single axle shredder device, wherein the size of each of aforementioned pieces is from 1 mm to 30 mm;
Step 3-1: Supplying aforementioned pieces to the variable frequency furnace via a channel;

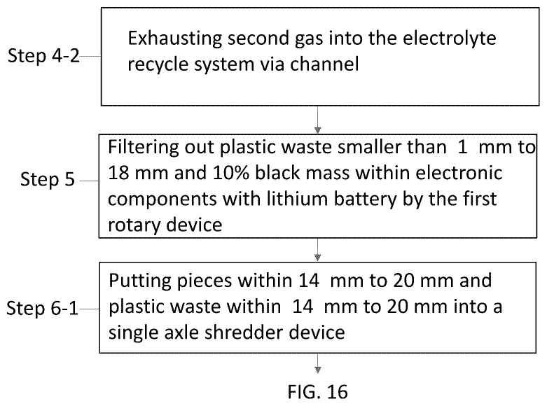

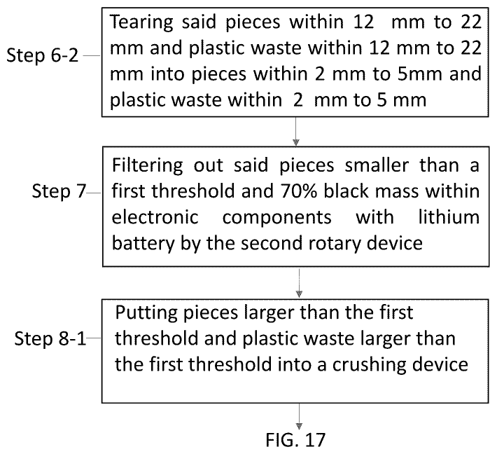

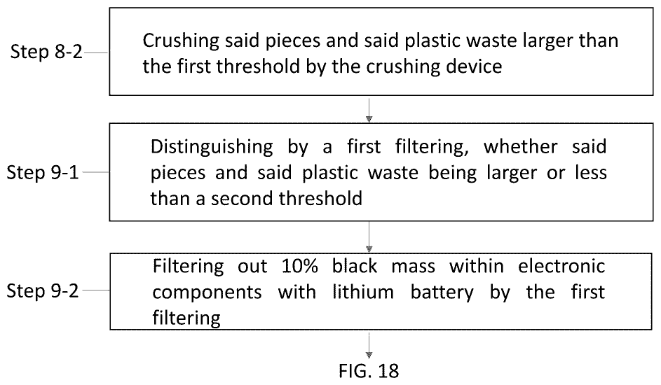

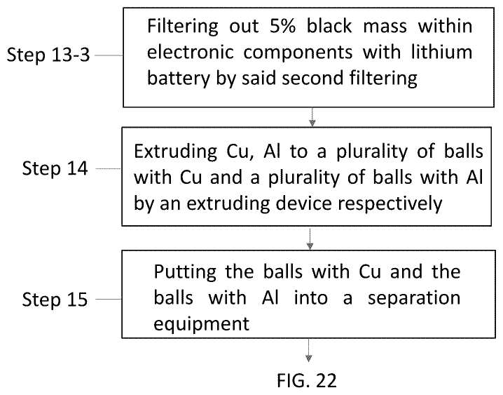

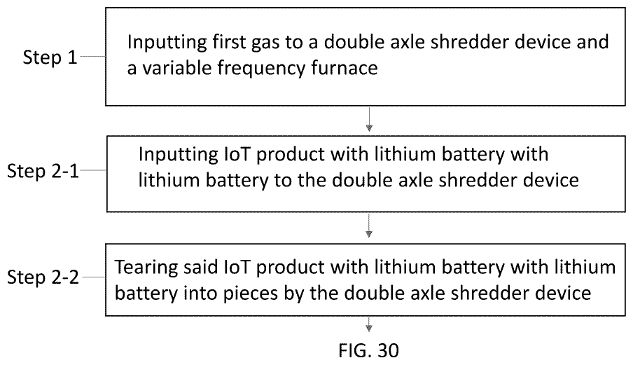

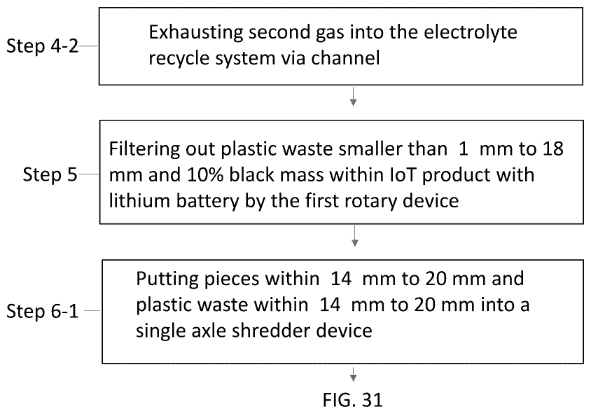

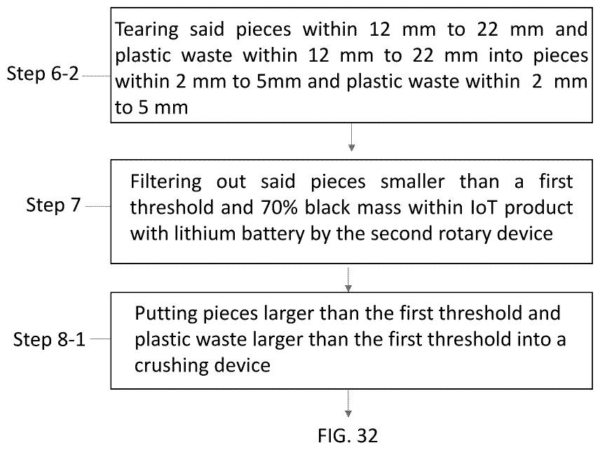

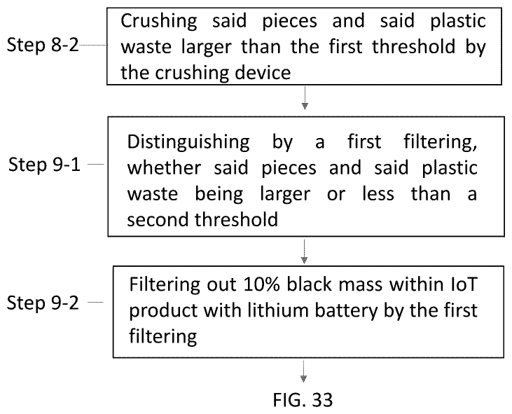

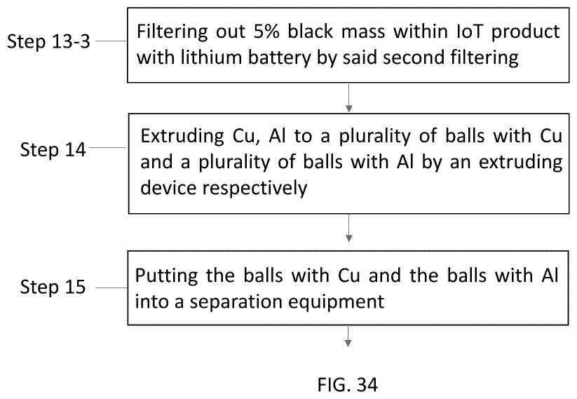

Please refer to FIGS. 30, 31, 32, 33 and 34, which are the flowcharts illustrating steps of the method for recycling electronic components bearing lithium battery according to an embodiment of the disclosure. The steps of the method differing from the ones in FIG. 14, FIG. 16, FIG. 17, FIG. 18, FIG. 22 are described as follows:
Step 1: Inputting first gas to a double axle shredder device and a variable frequency furnace, aforementioned double axle shredder device has a plurality of blades, each of the blades is made by carbon steel (C: 0.6%˜2%), or Alloy steel (C: 0.13-0.18; CR: 0.90-1.20), wherein aforementioned first gas is, for example, Nitrogen;
Step 2-1: Inputting IoT product with lithium battery with lithium battery to the single axle shredder device;
Step 2-2: Tearing said IoT product with lithium battery with lithium battery into pieces by the single axle shredder device, wherein the size of each of aforementioned pieces is from 1 mm to 30 mm;
Step 4-2: Exhausting second gas into the electrolyte recycle system via channel, wherein aforementioned second gas is cooled and cleaned in the electrolyte recycle system, wherein aforementioned heated, then cooled pieces and plastic waste enter into a first rotary device via channel;
Step 5: Filtering out plastic waste smaller than 1 mm to 18 mm and 10% black mass within IoT product with lithium battery by the first rotary device;
Step 6-1: Putting pieces within 14 mm to 20 mm and plastic waste within 14 mm to 20 mm into a single axle shredder device;
Step 6-2: Tearing said pieces within 12 mm to 22 mm and plastic waste within 12 mm to 22 mm into pieces within 2 mm to 5 mm and plastic waste within 2 mm to 5 mm, wherein aforementioned said pieces within 2 mm to 5 mm pieces enter into a second rotary device via channel;
Step 7: Filtering out said pieces smaller than a first threshold, for example, 1 mm to 5 mm, and 70% black mass within IoT product with lithium battery by the second rotary device;
Step 8-1: Putting pieces larger than the first threshold, for example, 1 mm to 5 mm and plastic waste larger than the first threshold, for example, 1 mm to 5 mm into a crushing device, wherein said crushing device is, for example, a Hammer mill;
Step 8-2: Crushing said pieces and said plastic waste larger than the first threshold, for example, 1 mm to 5 mm, by the crushing device;
Step 9-1: Distinguishing by a first filtering, whether said pieces and said plastic waste being larger or less than a second threshold, wherein the second threshold is, for example, 3.5 mm, wherein said first filtering is, for example, a vibration sieve;
Step 9-2: Filtering out 10% black mass within IoT product with lithium battery by the first filtering;
Step 13-3: Filtering out 5% black mass within IoT product with lithium battery by said second filtering;
Step 14: Extruding Cu, Al to a plurality of balls with Cu and a plurality of balls with Al by an extruding device respectively, wherein said extruding device is, for example, a ball generator;
Step 15: Putting the balls with Cu and the balls with Al into a separation equipment, wherein the separation equipment is, for example, a Density Separator.

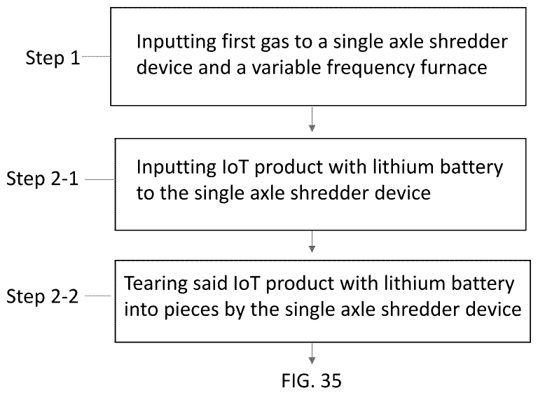

Please refer to FIG. 35, which is a flowchart illustrating steps of the method for recycling electronic components bearing lithium battery according to an embodiment of the disclosure. The steps of the method differing from the ones in FIG. 14 are described as follows:
Step 1: Inputting first gas to a single axle shredder device and a variable frequency furnace, aforementioned double axle shredder device has a plurality of blades, each of the blades is made by carbon steel (C: 0.6%˜2%), or Alloy steel (C: 0.13-0.18; CR: 0.90-1.20), wherein aforementioned first gas is, for example, Nitrogen;
Step 2-1: Inputting IoT product with lithium battery to the single axle shredder device;
Step 2-2: Tearing said IoT product with lithium battery into pieces by the single axle shredder device, wherein the size of each of aforementioned pieces is from 1 mm to 30 mm.

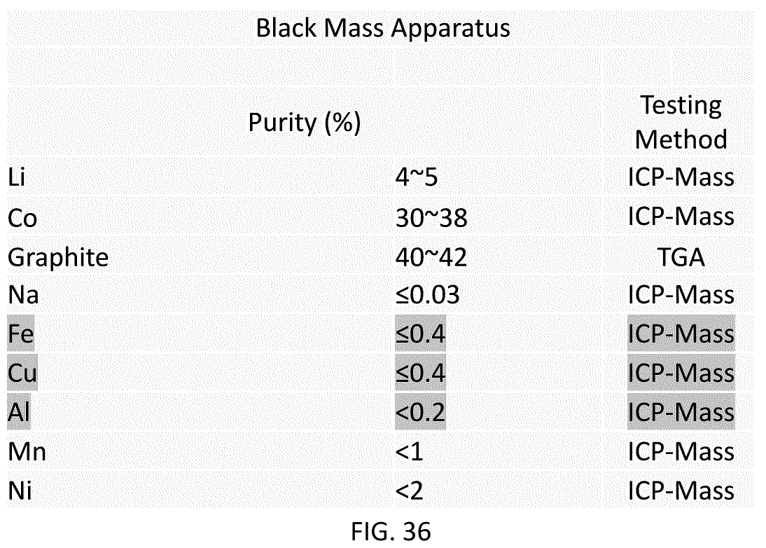

Please refer to FIG. 36, which is a diagram showing an operational test result of an apparatus and a method for recycling electronic components bearing lithium battery according to an embodiment of the disclosure. The test result shows that the impurities Fe, Cu, and Al in the black mass are below 1%. That is, according to the apparatus and method of the disclosure, the electronic components bearing lithium battery are directly placed in the apparatus for decomposition and recycling. There is no need to manually disassemble the electronic components in advance. The apparatus and method decompose the black mass with low impurities efficiently. The disclosure provides a high-efficiency recycling apparatus and method.

Although the disclosure has been disclosed by the foregoing embodiments, the embodiments are not intended to limit the disclosure. Persons skilled in the art may make some modifications and changes without departing from the spirit and scope of the disclosure.

What is claimed is:

1. An apparatus for recycling electronic components bearing lithium battery, the apparatus comprising:
a single axle shredder device;
a double axle shredder device;
a variable frequency furnace;
a first rotary device;
a second rotary device;
a crushing device;
a first filtering;
a second filtering;
a transporting device;
a sorting equipment;
an extruding device;
a separation equipment; and
a black mass collector;
wherein the double axle shredder device, the single axle shredder device, the variable frequency furnace, the first rotary device, the second rotary device, the crushing device, the first filtering, the second filtering, the transporting device, the sorting equipment, the extruding device, the separation equipment, and the black mass collector are connected to each other through one or more channels.

2. The apparatus of claim 1, the apparatus further comprises:
a cyclone material collector; and
an electrolyte recycle system;
wherein the cyclone material collector and the electrolyte recycle system are connected to each other through one or more channels.

3. The apparatus of claim 2, wherein the electrolyte recycle system includes:
a collecting tower;
a combustion chamber;
a cooling chamber;
a deodorizing system; and
a scrubber;
wherein the collecting tower, the combustion chamber, the cooling chamber, the deodorizing system and the scrubber are located in different places of the electrolyte recycle system.

4. The apparatus of claim 2, wherein the second filtering is a Circular Sieve, the extruding device is a ball generator, the separation equipment is a Density Separator, and the cyclone material collector is a pulse dust collector.

5. The apparatus of claim 1, wherein the double axle shredder device has a plurality of blades, each of the blades is made by carbon steel or Alloy steel.

6. The apparatus of claim 1, wherein the crushing device is a Hammer mill, the transporting device is an Iron Removal and the sorting equipment is an eddy current.

7. The apparatus of claim 1, wherein the first rotary device has an inner filter and an outer filter.

8. The apparatus of claim 7, wherein an aperture size to the inner filter is 14 mm and an aperture size to the outer filter is, for example 106 μm.

9. The apparatus of claim 1, wherein the second rotary device has an inner filter and an outer filter.

10. The apparatus of claim 9, wherein an aperture size to the inner filter is 4 mm and an aperture size to the outer filter is 106 μm.

11. A method for recycling electronic components bearing lithium battery, the method comprising:
inputting first gas to a single axle shredder device and a double axle shredder device selectively, and to a variable frequency furnace;
inputting electronic components with lithium battery to the single axle shredder device and the double axle shredder device selectively;
tearing the electronic components with lithium battery into a plurality of pieces by the single axle shredder device and the double axle shredder device selectively;
supplying the plurality of pieces to the variable frequency furnace via a channel; and
heating the plurality of pieces within the variable frequency furnace.

12. The method of claim 11, further comprising:
filtering out plastic waste smaller than 1 mm to 18 mm and 10% black mass within electronic components with lithium battery by a first rotary device.

13. The method of claim 12, further comprising:
putting a plurality of pieces within 14 mm to 20 mm and plastic waste within 14 mm to 20 mm into a single axle shredder device; and
tearing a plurality of pieces within 12 mm to 22 mm and plastic waste within 12 mm to 22 mm into a plurality of pieces within 2 mm to 5 mm and plastic waste within 2 mm to 5 mm.

14. The method of claim 13, further comprising:
filtering out a plurality of pieces smaller than a first threshold and 70% black mass within electronic components with lithium battery by a second rotary device.

15. The method of claim 14, further comprising:
putting the plurality of pieces larger than the first threshold and plastic waste larger than the first threshold into a crushing device; and crushing the plurality of pieces and the plastic waste larger than the first threshold by the crushing device.

16. The method of claim 15, further comprising:
distinguishing by a first filtering, whether a plurality of pieces and the plastic waste being larger or less than a second threshold; and filtering out 10% black mass within electronic components with lithium battery by the first filtering.

17. The method of claim 16, further comprising:
transporting the plurality of pieces and the plastic waste larger than the second threshold from the first filtering to a transporting device via channel;
filtering out magnetic material having iron from the plurality of pieces and the plastic waste by the transporting device;
transporting the plurality of pieces and the plastic waste larger than the second threshold from the first filtering to a sorting equipment via channel; and
filtering out hard plastic, a plurality of pieces of PCB and Al from the plurality of pieces and the plastic waste by the eddy current.

18. The method of claim 17, further comprising:
transporting the plurality of pieces and the plastic waste less than the second threshold from the first filtering to the crushing device; and crushing the plurality of pieces and the plastic waste less than the second threshold by the crushing device.

19. The method of claim 18, further comprising:
transporting crushed pieces and plastic waste within the sorting equipment, the transporting device and the crushing device into a second filtering;
distinguishing Cu, Al, and black mass by the second filtering; and
filtering out 5% black mass within electronic components with lithium battery by the second filtering.

20. The method of claim 19, further comprising:
extruding Cu, Al to a plurality of balls with Cu and a plurality of balls with Al by an extruding device respectively; and
putting the balls with Cu and the balls with Al into a separation equipment.
